(19) United States
(12) Patent Application Publication
(10) Pub. No.: US 2026/0064076 A1
(43) Pub. Date: Mar. 5, 2026

(54) IMAGE FORMING APPARATUS AND PROCESSING METHOD

(71) Applicant: CANON KABUSHIKI KAISHA, Tokyo (JP)

(72) Inventor: TAISHI MASUMITSU, Chiba (JP)

(21) Appl. No.: 19/311,754

(22) Filed: Aug. 27, 2025

(30) Foreign Application Priority Data
Sep. 3, 2024 (JP) 2024-151524

(51) Int. Cl. G03G 21/18; B41J 2/175; G03G 15/00

(52) U.S. Cl. CPC G03G 21/1889; B41J 2/17546; G03G 15/553; G03G 21/1892; G03G 2215/0697

(57) ABSTRACT

An image forming apparatus includes one or more memories storing instructions, and one or more processors configured to execute the instructions to perform a delivery request for a new consumable when a remaining amount of the consumable is less than or equal to a threshold, and in response to detecting attachment of the new consumable, change the threshold to a new threshold based on the threshold, capacity information of the new consumable, and capacity information of a previously attached consumable.

### BACKGROUND

### Field of the Technology

The present disclosure relates to an image forming apparatus and a processing method.

### Description of the Related Art

There is a known automatic consumable delivery service in which consumables used for printing in an image forming apparatus are automatically delivered to a user. Generally, when a remaining amount of a consumable becomes lower than a predetermined threshold, the image forming apparatus that supports the automatic consumable delivery service is configured to request the delivery of a new consumable from a management server that manages information about the service. Further, in the automatic consumable delivery service, it is important for consumables to be delivered at appropriate timing for the user in terms of convenience.

To improve user's convenience, for example, Japanese Patent Application Laid-Open No. 2020-102254 discusses a technique of displaying an input screen on an image forming apparatus or an information processing apparatus, and ordering consumables based on a condition input by the user.

There are cases where a consumable is detached from the image forming apparatus and replaced with a new consumable having a different capacity. In such cases, the consumable may not be delivered at a timing desired by the user even though the user has input the delivery condition for the consumable. For example, this occurs when a threshold of the remaining amount for requesting the delivery can be input as a percentage relative to the capacity of the consumable. Thus, the delivery condition for the consumable also needs considering the capacity of the consumable used by the user.

### SUMMARY

According to an aspect of the present disclosure, an image forming apparatus includes one or more memories storing instructions, and one or more processors configured to execute the instructions to perform a delivery request for a new consumable when a remaining amount of the consumable is less than or equal to a threshold, and in response to detecting attachment of the new consumable, change the threshold to a new threshold based on the threshold, capacity information of the new consumable, and capacity information of a previously attached consumable.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating a configuration example of an image processing system.

FIG. 2 is a flowchart of processing in which an image forming apparatus changes a delivery threshold setting.

FIG. 3 is a diagram illustrating a setting screen of the delivery threshold setting.

FIG. 4 is a flowchart of print processing performed by the image forming apparatus.

FIG. 5 is a flowchart of ink tank attachment processing performed by the image forming apparatus.

FIG. 6 is a diagram illustrating a change screen of the delivery threshold setting.

FIG. 7 is a flowchart of processing in which the image forming apparatus changes automatic delivery threshold setting.

FIG. 8 is a diagram illustrating a change screen of the automatic delivery threshold setting.

FIG. 9 is a flowchart of the ink tank attachment processing performed by the image forming apparatus.

### DESCRIPTION OF THE EMBODIMENTS

Some exemplary embodiments will now be described with reference to the drawings. It should be understood that the present disclosure also includes appropriate modifications and improvements of the following embodiments based on general knowledge of a person skilled in the art without departing from the spirit of the present disclosure.

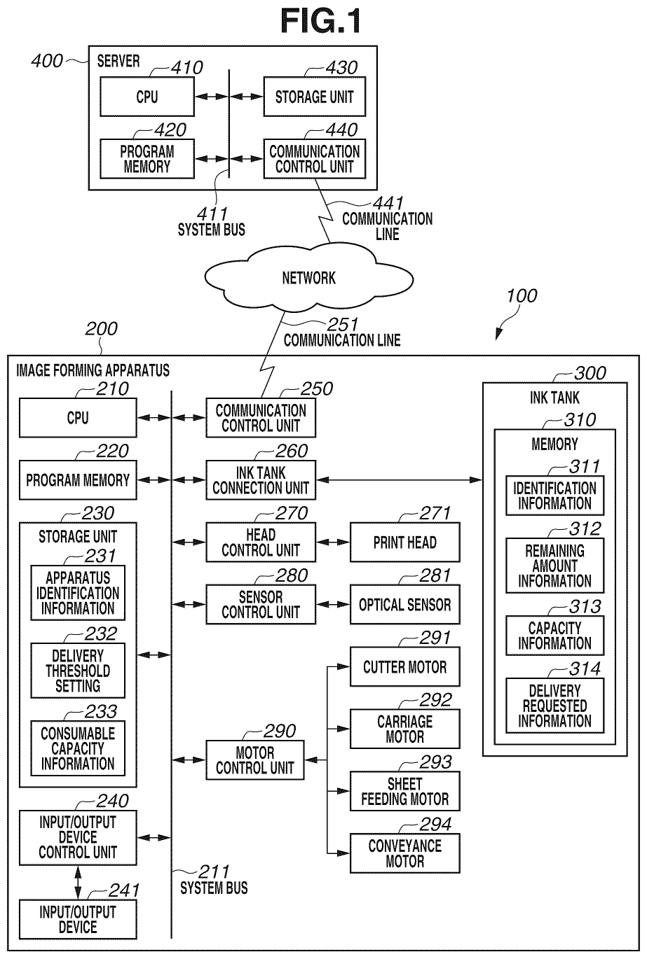

A first exemplary embodiment will now be described. FIG. 1 is a block diagram illustrating a configuration example of an image processing system 100 according to the present exemplary embodiment. The image processing system 100 includes an image forming apparatus 200, an ink tank 300, and a server 400.

The image forming apparatus 200 has a printing function that performs printing operation using a recording material, and is, for example, a large-format inkjet printer. The image forming apparatus 200 includes a central processing unit (CPU) 210, a program memory 220, a storage unit 230, an input and output device control unit 240, a communication control unit 250, an ink tank connection unit 260, a head control unit 270, a sensor control unit 280, and a motor control unit 290. These units are connected via a system bus 211.

The CPU 210 is a system control unit that controls the entire image forming apparatus 200. The program memory 220 stores control programs to be executed by the CPU 210, a built-in operating system (OS) program, and the like.

The storage unit 230 includes various kinds of work buffer areas for storing program control variables used in control of the image forming apparatus 200 and the like, and a nonvolatile storage area for storing setting information necessary for various kinds of operations. The storage unit 230 further holds apparatus identification information 231, a delivery threshold setting 232, and consumable capacity information 233.

The apparatus identification information 231 is information for identifying an individual unit, which is assigned in the manufacturing of the image forming apparatus 200, and is, for example, a serial number.

The delivery threshold setting 232 is a threshold of a remaining amount of the ink tank 300, the threshold of which the image forming apparatus 200 uses to request delivery of a new ink tank 300 from the server 400 in the automatic consumable delivery service. In the present exemplary embodiment, the delivery threshold setting 232 can be set with a percentage of the remaining amount relative to the capacity of the ink tank 300. In the present exemplary embodiment, the initial value of the delivery threshold setting 232 is 10%. If a plurality of ink tanks 300 is attachable in the image forming apparatus 200, the delivery threshold setting 232 is individually settable for each type (e.g., ink color) of the attached ink tanks 300, and delivery thresholds of all attached ink tanks 300 are held in the storage unit 230.

The consumable capacity information 233 is capacity information 313 acquired from the ink tank 300 by the image forming apparatus 200 at desired timing. If a plurality of ink tanks 300 is attachable in the image forming apparatus 200, the image forming apparatus 200 holds the capacity information 313 about all attached ink tanks 300 as the consumable capacity information 233 in the storage unit 230.

The input and output device control unit 240 controls the commands executed between the image forming apparatus 200 and an input and output device 241. The input and output device 241 includes hardware keys and a panel for the user to configure various settings and operations with, and a display unit to display (notify) various information to the user.

The communication control unit 250 controls data exchange with the outside of the image forming apparatus 200 via a communication line 251 and various kinds of interfaces.

The ink tank connection unit 260 connects the image forming apparatus 200 and the ink tank 300.

In the present exemplary embodiment, an example is described where the ink tanks 300 of four colors of cyan, magenta, yellow, and black are attachable in the image forming apparatus 200 via the ink tank connection unit 260. The ink tank connection unit 260 receives information acquisition requests at desired timing, and acquires information about the ink tanks 300 from a memory 310.

The head control unit 270 performs control relating to the operation of a print head 271. The print head 271 is a printing unit that prints images on sheets based on image data. The print head 271 includes, for example, a plurality of print heads corresponding to a plurality of colors, and ejects ink in synchronization with conveyance of a sheet, forming an image on the sheet.

The sensor control unit 280 performs control relating to the operation of various kinds of sensors including an optical sensor 281. The optical sensor 281 is a measurement unit for measuring attribute values of printing recording media including roll paper, and is a reflective optical sensor including a light-emitting diode (LED) as a light emitting element, a specular-reflected light receiving element, a diffused light receiving element, and the like. The image forming apparatus 200 uses the optical sensor 281 to measure the attribute values of a sheet on a platen, such as the intensities of specular-reflected light and diffused light, and the thickness of the sheet.

The motor control unit 290 performs control relating to the operation of various kinds of motors including a cutter motor 291, a carriage motor 292, a sheet feeding motor 293, and a conveyance motor 294.

The cutter motor 291 drives a cutter unit that cuts off the roll paper used as a recording medium. In cutting off roll paper, the cutter motor 291 is driven to cut off the roll paper subjected to image printing to a predetermined length.

The carriage motor 292 drives a carriage of the print head 271.

The sheet feeding motor 293 rotates a roll paper tube to convey the roll paper in cooperation with the conveyance motor 294. By driving the sheet feeding motor 293 to rotate the roll paper tube in the reverse direction, the roll paper on the conveyance roller can be wound to the roll paper tube.

The conveyance motor 294 drives a conveyance roller that conveys the roll paper.

The ink tank 300 can be attached and replaced in the image forming apparatus 200, and is filled with ink used as a recording material for printing. The ink tank 300 includes the memory 310.

The memory 310 holds identification information 311, remaining amount information 312, the capacity information 313, and delivery requested information 314.

The identification information 311 is information for identifying an individual unit, which is assigned in the manufacturing of the ink tank 300, and is, for example, a serial number.

The remaining amount information 312 is information about a remaining amount of ink in an ink tank 300, and may be represented in units of volume or as remaining amount levels divided by predetermined thresholds.

The capacity information 313 is information about an amount of ink with which the ink tank 300 is filled in an unused state (i.e., a capacity of ink tank 300), and is represented in units of volume.

The delivery requested information 314 is information indicating whether the image forming apparatus 200 has requested the delivery of an ink tank 300 from the server 400. If the image forming apparatus 200 has not requested the delivery, the delivery requested information 314 is a value representing OFF as an initial value. If the delivery is requested, a value representing ON is written by the image forming apparatus 200. The image forming apparatus 200 acquires and updates the delivery requested information 314 via the ink tank connection unit 260, preventing the delivery of the same ink tank 300 from being requested two or more times.

The server 400 is a server on the service providing side that manages information about users who have contracted the automatic consumable delivery service and about the image forming apparatus 200, and includes a CPU 410, a program memory 420, a storage unit 430, and a communication control unit 440.

The CPU 410 is a system control unit that controls the entire server 400.

The program memory 420 stores control programs to be executed by the CPU 410, a built-in OS program, and the like.

The storage unit 430 holds information about the users having contracted the automatic consumable delivery service, the apparatus identification information 231 about the image forming apparatus 200 used in the automatic consumable delivery service, and the identification information 311 about the ink tank 300 requested to be delivered by the image forming apparatus 200.

The communication control unit 440 controls data exchange with the outside via a communication line 441.

The above-described components 410 to 440 are mutually connected via a system bus 411 managed by the CPU 410.

In the present exemplary embodiment, an inkjet printer is exemplified as the image forming apparatus 200. However, the present exemplary embodiment is applicable to, for example, a full-color laser beam (electrophotographic) printer and a monochrome printer.

In the present exemplary embodiment, as an example of the consumables, the ink tank 300 is described. However, the consumables are not limited to the ink tanks 300, and may be ink cartridges, toner cartridges, or the like.

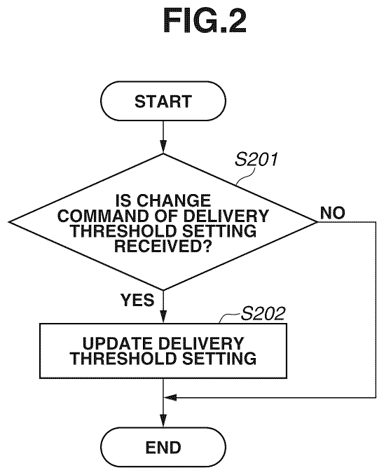

A processing method for changing the delivery threshold setting 232 of the image forming apparatus 200 will be described with reference to FIG. 2.

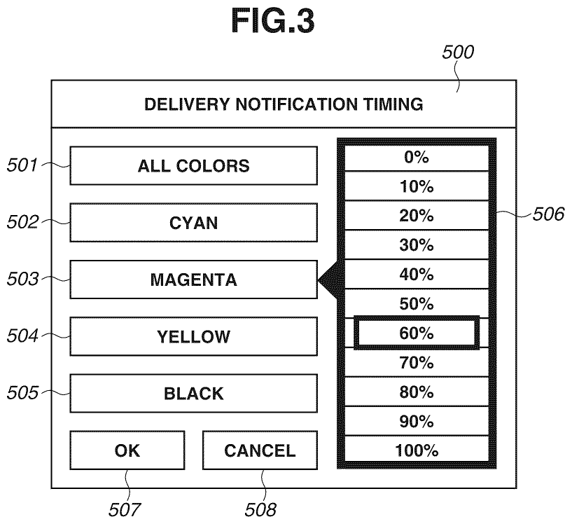

In step S201, the CPU 210 determines whether a change command of the delivery threshold setting 232 is received from a user by a desired method. The change command of the delivery threshold setting 232 is received from an input on a setting screen displayed on the display unit of the input and output device 241 or a user's host terminal (e.g., a personal computer (PC) or a smartphone) communicable with the image forming apparatus 200 via the communication control unit 250. Further, as described above, in the case where a plurality of ink tanks 300 is attachable in the image forming apparatus 200, the delivery threshold setting 232 is individually settable for each type (e.g., ink color) of the attached ink tanks 300. An example of the setting screen displayed on the display unit of the input and output device 241 will be described below with reference to FIG. 3. If it is determined that the change command is received (YES in step S201), the processing proceeds to step S202. If it is determined that the change command is not received (NO in step S201), the processing in the flowchart ends.

In step S202, the CPU 210 updates the delivery threshold setting 232 with the value input by the user. If the CPU 210 has received the change command of the delivery threshold setting for a specific type of the ink tank 300 alone in step S201, the CPU 210 updates the delivery threshold setting 232 alone of the corresponding ink tank 300 in step S202.

An example of the setting screen of the delivery threshold setting 232 displayed on the display unit of the input and output device 241 will now be described with reference to FIG. 3.

A delivery threshold setting screen 500 is displayed on the display unit of the input and output device 241.

A setting button for all colors 501 is used to collectively change the delivery threshold settings 232 of all ink tanks 300 attached in the image forming apparatus 200 to the same value.

A cyan setting button 502 is used to change the delivery threshold setting 232 of the ink tank 300 of cyan color. A magenta setting button 503, a yellow setting button 504, and a black setting button 505 are used to change the delivery threshold settings 232 of the respective ink colors, as with the cyan setting button 502.

A delivery threshold input button 506 is displayed when any of the buttons from the setting button for all colors 501 to the black setting button 505 is pressed, and is used to select and input a delivery threshold from among options. In the present exemplary embodiment, an example is described where a delivery threshold can be selected and input from setting values in 10% increments within the range of 0% to 100% using the delivery threshold input button 506. However, the user may input the delivery threshold in 1% increments.

A setting change execution button 507 is used to perform a setting change of the delivery threshold setting 232. When the setting change execution button 507 is pressed, the CPU 210 updates the delivery threshold setting 232 of the ink tank 300 with the value input by the user.

A setting change cancel button 508 is used to cancel the setting change of the delivery threshold setting 232. When the setting change cancel button 508 is pressed, the CPU 210 ends the processing without receiving the change command of the delivery threshold setting 232.

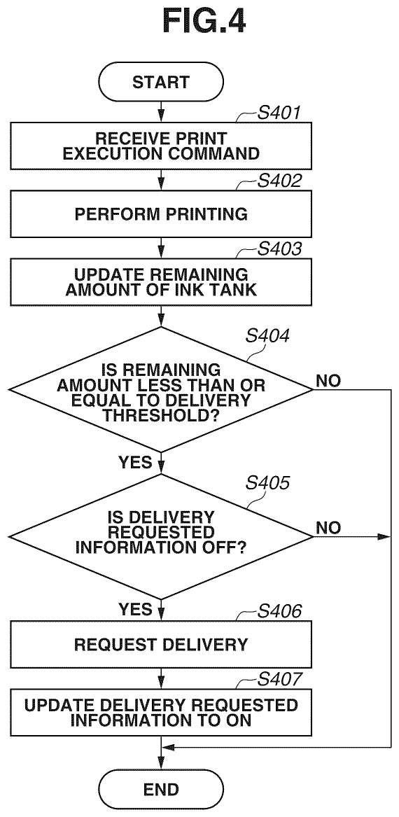

A processing method when the image forming apparatus 200 using the automatic consumable delivery service performs print processing will now be described with reference to FIG. 4.

In step S401, the CPU 210 receives an execution command of print processing from the user by a desired method. The execution command of print processing is received by, for example, pressing of a print start button displayed on the display unit of the input and output device 241.

In step S402, the CPU 210 performs print processing corresponding to the execution command received in step S401. At this time, the CPU 210 calculates an amount of ink consumption in the print processing.

In step S403, the CPU 210 updates the remaining amount information 312 about the ink tank 300 by using the amount of ink consumption calculated in step S402.

In step S404, the CPU 210 determines whether the remaining amount information 312 about the ink tank 300 is less than or equal to the delivery threshold based on the delivery threshold setting 232. The setting value of the delivery threshold setting 232 indicates the delivery threshold. If it is determined that the remaining amount is less than or equal to the delivery threshold (YES in step S404), the processing proceeds to step S405. If it is determined that the remaining amount is not less than or equal to the delivery threshold (NO in step S404), the processing in the flowchart ends. In the case where a plurality of ink tanks 300 is attachable in the image forming apparatus 200 as in the present exemplary embodiment, the processing proceeds to step S405 if even one ink tank 300 exists in which the remaining amount information 312 is less than or equal to the delivery threshold.

In step S405, the CPU 210 determines whether the delivery requested information 314 about the ink tank 300 indicates OFF. If it is determined that the delivery requested information 314 indicates OFF (YES in step S405), the processing proceeds to step S406. If it is determined that the delivery requested information 314 does not indicates OFF (i.e., indicates ON) (NO in step S405), the processing in the flowchart ends. In the case where a plurality of ink tanks 300 is attachable in the image forming apparatus 200 as in the present exemplary embodiment, the processing proceeds to step S406 if even one ink tank 300 exists in which the delivery requested information 314 indicates OFF.

In step S406, the CPU 210 functions as a delivery request unit, and requests the delivery of a new ink tank 300 from the server 400. The information notified from the image forming apparatus 200 to the server 400 by the delivery request includes the apparatus identification information 231 and the identification information 311 about the ink tank 300. In the present exemplary embodiment, the delivery of a new ink tank 300 for the ink tank 300 whose remaining amount information 312 is less than or equal to the delivery threshold and the delivery requested information 314 indicates OFF is requested. However, depending on an exemplary embodiment, if the delivery requested information 314 indicates OFF, the delivery request of a new ink tank 300 may also be made for the ink tank 300 whose remaining amount information 312 is not less than or equal to the delivery threshold.

In step S407, the CPU 210 records the execution of the delivery request in the memory 310 of the ink tank 300 by updating the delivery requested information 314 about the ink tank 300 requested to be delivered in step S406 to ON. The processing in the flowchart then ends.

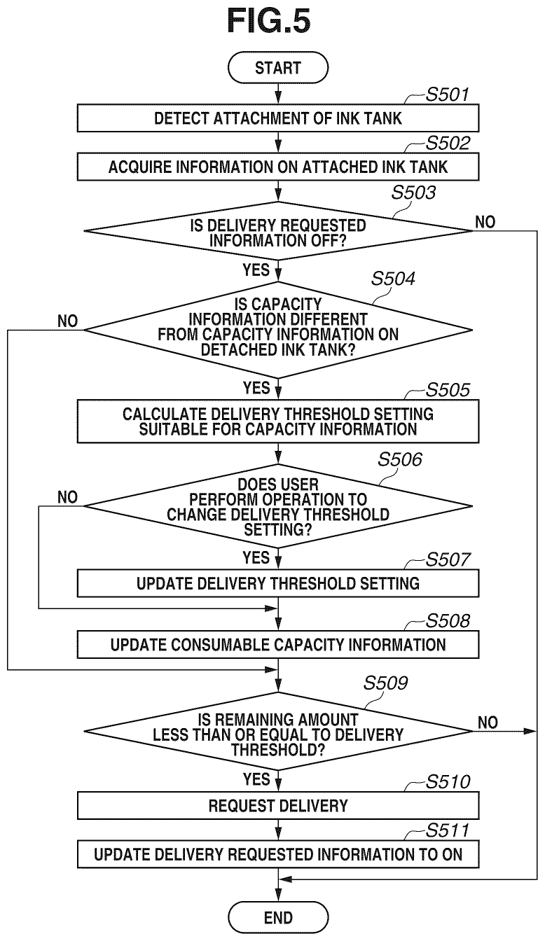

A processing method when the ink tank 300 is attached in the image forming apparatus 200 will now be described with reference to FIG. 5.

In step S501, the CPU 210 detects the attachment of the ink tank 300 via the ink tank connection unit 260.

In step S502, the CPU 210 acquires information about the ink tank 300 of which the attachment is detected.

In step S503, the CPU 210 determines whether the delivery requested information 314 about the ink tank 300 indicates OFF. If it is determined that the delivery requested information indicates OFF (YES in step S503), the processing proceeds to step S504. If it is determined that the delivery requested information 314 does not indicate OFF (i.e., indicates ON) (NO in step S503), the processing in the flowchart ends. In the case where a plurality of ink tanks 300 is attachable in the image forming apparatus 200 as in the present exemplary embodiment, and attachment of a plurality of ink tanks 300 is detected at the same time, the determination processing is performed on all ink tanks 300 of which the attachment is detected.

In step S504, the CPU 210 determines whether the consumable capacity information 233 held in the storage unit 230 and the capacity information 313 about the ink tank 300 indicate different values from each other. In this case, the consumable capacity information 233 is the capacity information 313 about the ink tank 300 attached in the image forming apparatus 200 before the ink tank 300 attached in step S501. In other words, in step S504, the CPU 210 compares the capacity information 313 about the detached ink tank 300 and the capacity information 313 about the ink tank 300 of which the attachment is newly detected. If it is determined that the consumable capacity information 233 and the capacity information 313 indicate different values from each other (YES in step S504), the processing proceeds to step S505. If it is determined that the consumable capacity information 233 and the capacity information 313 indicate the same value (NO in step S504), the processing proceeds to step S509.

In step S505, the CPU 210 calculates the setting value of the delivery threshold setting 232 suitable for the capacity information 313 about the ink tank 300 attached in step S501. In the present exemplary embodiment, the CPU 210 calculates a new setting value Sn of the delivery threshold setting 232 using the following expression (1) based on the consumable capacity information 233, the capacity information 313, and the delivery threshold setting 232.

$$Sn = ( Cp \times Sb ) / Cs \qquad ( 1 )$$

In the expression, Cs is the consumable capacity information 233, Cp is the capacity information 313, and Sb is the delivery threshold setting 232.

Specifically, Cp is the capacity information about the ink tank 300 of which the attachment is detected in step S501, and Cs is the capacity information about the ink tank 300 attached before the ink tank 300 of which the attachment is detected in step S501. Further, Sb is the setting value (the delivery threshold) of the delivery threshold setting 232 in step S404 of FIG. 4, and Sn is a new setting value (delivery threshold) of the delivery threshold setting 232.

In step S501, the CPU 210 detects attachment of the ink tank 300 through replacement of the ink tank 300. In step S505, the CPU 210 calculates the new setting value (the delivery threshold) Sn of the delivery threshold setting 232 using the expression (1) based on the capacity information Cp about the ink tank 300 after the replacement, the capacity information Cs on the ink tank 300 before the replacement, and the current setting value (the delivery threshold) Sb of the delivery threshold setting 232.

In step S506, the CPU 210 displays, on the display unit of the input and output device 241, a change screen where the user changes or does not change the setting value of the delivery threshold setting 232 to the setting value Sn calculated in step S505, and receives a user operation to change or not change the setting value to the setting value Sn.

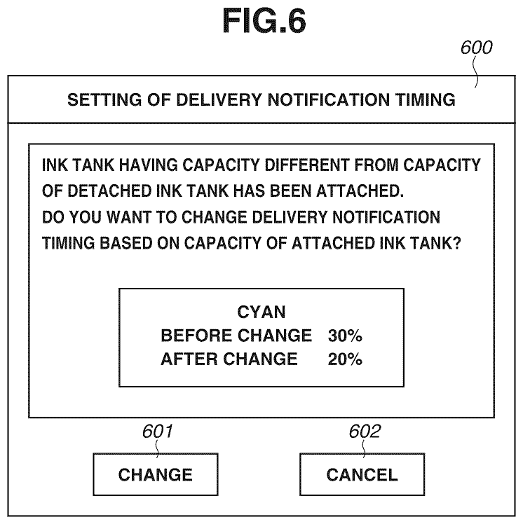

An example of the change screen displayed on the display unit of the input and output device 241 at this time will be described below with reference to FIG. 6. If the user performs an operation to change the delivery threshold setting 232 to the setting value Sn (YES in step S506), the processing proceeds to step S507. If the user performs an operation not to change the delivery threshold setting 232 (NO in step S506), the processing proceeds to step S508.

In step S507, the CPU 210 functions as a change unit that changes (updates) the current setting value of the delivery threshold setting 232 to the setting value Sn of the delivery threshold setting 232 calculated in step S505. At this time, the CPU 210 may display a screen indicating the completion of the setting change on the display unit of the input and output device 241.

In step S508, the CPU 210 updates the consumable capacity information 233 with the capacity information 313 about the ink tank 300 attached in step S501.

The pieces of the processing in steps S509 to S511 are respectively similar to those in steps S404, S406, and S407 in the flowchart of FIG. 4. Thus, the description thereof will be omitted.

An example of the change screen of the delivery threshold setting 232 displayed on the display unit of the input and output device 241 will be described with reference to FIG. 6.

A delivery threshold change screen 600 is displayed on the display unit of the input and output device 241.

A setting change button 601 is used to perform a setting change of the delivery threshold setting 232. When the setting change button 601 is pressed, the CPU 210 updates the delivery threshold setting 232 of the ink tank 300 with the setting value Sn calculated in step S505.

A setting change cancel button 602 is used to cancel the setting change of the delivery threshold setting 232. When the setting change cancel button 602 is pressed, the CPU 210 ends the processing without changing the delivery threshold setting 232.

According to the present exemplary embodiment, the image forming apparatus 200 can set the delivery threshold for a consumable (e.g., the ink tank 300) via a user input. In addition, the image forming apparatus 200 calculates the delivery threshold suitable for the capacity of an attached consumable, and prompts the user to change the setting. Thus, for the image forming apparatus 200 compatible with consumables having a plurality of types of capacities, the consumables can be delivered at appropriate timing for the user.

The image forming apparatus 200 is compatible with consumables having a plurality of types of capacities, and can request delivery of the consumables at appropriate timing for the user. This makes it possible to improve convenience for the user who uses the automatic consumable delivery service.

A second exemplary embodiment will now be described. In the first exemplary embodiment, when a consumable is detached from the image forming apparatus 200 and a consumable having a different capacity is newly attached in the image forming apparatus 200, the image forming apparatus 200 prompts the user to change the setting of the delivery threshold. However, the user who uses the automatic consumable delivery service may not wish to perform an input as to whether to change the delivery threshold each time a consumable having a different capacity is attached.

Thus, in the present exemplary embodiment, an example will be described where the image forming apparatus 200 can automatically change the delivery threshold setting 232 in response to attachment of the ink tank 300, and the user can perform a setting as to whether an automatic change is executed (hereinafter, referred to as an automatic delivery threshold setting).

A setting value of the automatic delivery threshold setting is held in an area (not illustrated) in the storage unit 230 of the image forming apparatus 200. The setting value is settable to any of Automatic ON, which refers to performing the automatic change, Manual ON, which refers to not performing the automatic change but changing the delivery threshold setting 232 to the setting value Sn via a user input as in the first exemplary embodiment, and OFF, which refers to not performing calculation of the setting value Sn using the expression (1). Further, the initial value of the setting value may be any of Automatic ON, Manual ON, and OFF.

In the present exemplary embodiment, the difference from the first exemplary embodiment will mainly be described, and the configurations that will not be described are similar to those in the first exemplary embodiment.

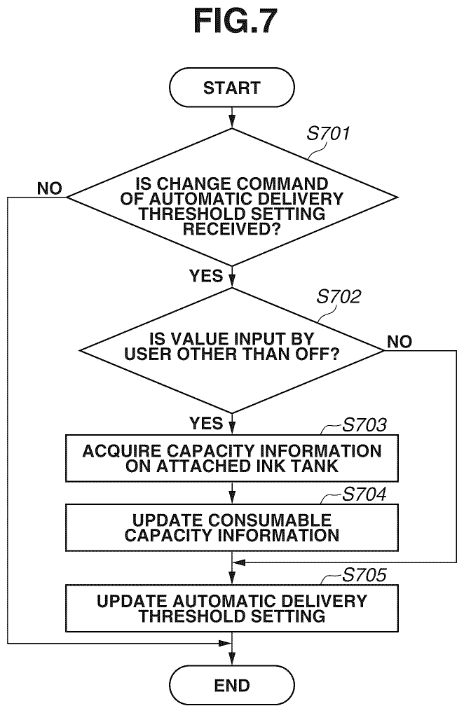

A processing method by which the image forming apparatus 200 changes the automatic delivery threshold setting will be described with reference to FIG. 7.

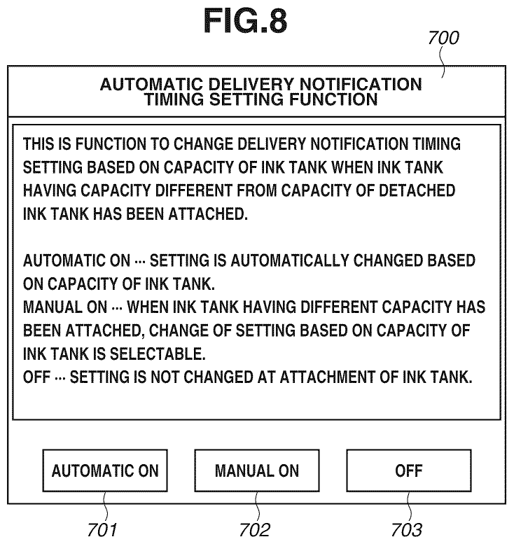

In step S701, the CPU 210 determines whether a change command of the automatic delivery threshold setting is received from the user by a desired method. The change command of the automatic delivery threshold setting is received via an input from a setting screen displayed on the display unit of the input and output device 241 or a user's host terminal (e.g., a PC or a smartphone) communicable with the image forming apparatus 200 via the communication control unit 250. An example of the setting screen displayed on the display unit of the input and output device 241 will be described below with reference to FIG. 8. If it is determined that the change command is received (YES in step S701), the processing proceeds to step S702. If it is determined that the change command is not received (NO in step S701), the processing in the flowchart ends.

In step S702, the CPU 210 determines whether a value input by the user in step S701 indicates a setting value other than OFF. If it is determined that the value indicates a setting value other than OFF (i.e., Automatic ON or Manual ON) (YES in step S702), the processing proceeds to step S703. If it is determined that the value indicates OFF (NO in step S702), the processing proceeds to step S705.

In step S703, the CPU 210 acquires the capacity information 313 about the attached ink tank 300.

In step S704, the CPU 210 updates the consumable capacity information 233 with the capacity information 313 acquired in step S703. If the automatic delivery threshold setting is set to Automatic ON or Manual ON, the CPU 210 calculates a new setting value Sn of the delivery threshold setting 232 using the expression (1) by using the consumable capacity information 233, the capacity information 313, and the setting value of the delivery threshold setting 232. Thus, the CPU 210 updates the consumable capacity information 233 at the timing when the automatic delivery threshold setting is set to Automatic ON or Manual ON.

In step S705, the CPU 210 updates the automatic delivery threshold setting with the value input by the user in step S701.

An example of the setting screen of the automatic delivery threshold setting displayed on the display unit of the input and output device 241 will be described with reference to FIG. 8.

An automatic delivery threshold setting screen 700 is displayed on the display unit of the input and output device 241. An Automatic ON setting button 701 is used to set the automatic delivery threshold setting to Automatic ON. When the automatic on setting button 701 is pressed, the CPU 210 determines that Automatic ON has been input by the user.

A Manual ON setting button 702 and an OFF setting button 703 are respectively used to set the automatic delivery threshold setting to Manual ON and OFF, as with the Automatic ON setting button 701.

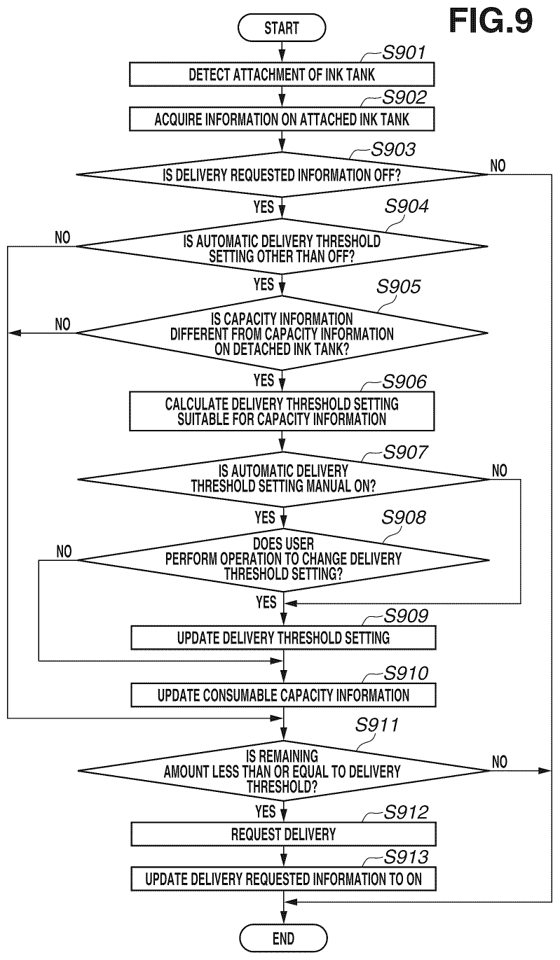

A processing method by which the ink tank 300 is attached in the image forming apparatus 200 will be described with reference to FIG. 9.

The pieces of the processing in steps S901 to S903 are respectively similar to those in steps S501 to S503 in the flowchart of FIG. 5. Thus, description thereof will be omitted.

In step S904, the CPU 210 determines whether the automatic delivery threshold setting is other than off. If it is determined that the automatic delivery threshold setting indicates a setting value other than OFF (i.e., Automatic ON or Manual ON) (YES in step S904), the processing proceeds to step S905. If it is determined that the automatic delivery threshold setting indicates OFF (NO in step S904), the processing proceeds to step S911.

The pieces of the processing in steps S905 and S906 are respectively similar to those in steps S504 and S505 in the flowchart of FIG. 5. Thus, description thereof will be omitted.

In step S907, the CPU 210 determines whether the automatic delivery threshold setting indicates Manual ON. If it is determined that the automatic delivery threshold setting indicates Manual ON (YES in step S907), the processing proceeds to step S908. If it is determined that the automatic delivery threshold setting does not indicate Manual ON (i.e., automatic on) (NO in step S907), the processing proceeds to step S909.

The pieces of the processing in steps S908 to S913 are respectively similar to those in steps S506 to S511 in the flowchart of FIG. 5. Thus, description thereof will be omitted.

As described above, if the automatic delivery threshold setting is in the mode of Manual ON, the CPU 210 changes the setting value of the delivery threshold setting 232 to a new setting value Sn based on a user operation to change the setting value of the delivery threshold setting 232 to the new setting value Sn in FIG. 6 or not.

In contrast, if the automatic delivery threshold setting is in the mode of Automatic ON, the CPU 210 changes the setting value of the delivery threshold setting 232 to the new setting value Sn without requiring a user operation to change the setting value of the delivery threshold setting 232 to the new setting value Sn in FIG. 6 or not.

According to the present exemplary embodiment, by the user's setting the automatic delivery threshold setting, setting of the delivery threshold can be changed to a delivery threshold suitable for the capacity of an attached consumable without performing an input as to whether to change the delivery threshold each time a consumable is attached. Thus, with the image forming apparatus 200 compatible with consumables having a plurality of types of capacities, the consumables can be delivered at appropriate timing for the user.

A third exemplary embodiment will now be described. To control whether a delivery request to the server 400 is executed, the CPU 210 of the image forming apparatus 200 may hold in the storage unit 230 service contract information indicating whether the user has contracted the automatic consumable delivery service. At this time, the CPU 210 may add, as a condition for executing a change of the delivery threshold setting 232 associated with attachment of the ink tank 300, the description that the service contract information is a value indicating a service contracted status. If the service contract information is a value other than the value indicating the service contracted status, the CPU 210 may perform control not to display the delivery threshold setting screen 500 or the automatic delivery threshold setting screen 700 on the display unit of the input and output device 241 and a host terminal of the user.

The above-described exemplary embodiments are merely specific examples for implementing the present disclosure, and the technical scope of the present disclosure is not limitedly interpreted by the above-described exemplary embodiments. In other words, the present disclosure can be implemented in various forms without departing from the technical idea or the main features of the present disclosure.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-151524, filed Sep. 3, 2024, which is hereby incorporated by reference herein in its entirety.

What is claimed is:

1. An image forming apparatus comprising:
one or more memories storing instructions; and
one or more processors configured to execute the instructions to:
perform a delivery request for a new consumable when a remaining amount of the consumable is less than or equal to a threshold; and
in response to detecting attachment of the new consumable, change the threshold to a new threshold based on:
the threshold,
capacity information of the new consumable, and
capacity information of a previously attached consumable.

2. The image forming apparatus according to claim 1, wherein the change to the new threshold is controlled based on a user operation indicating whether to change the threshold.

3. The image forming apparatus according to claim 1,
wherein, in a case where the delivery request is performed, an execution of the delivery request is recorded in an internal memory of the consumable,
wherein, in a case where the attachment of the consumable is detected in the image forming apparatus and the execution of the delivery request is recorded in the internal memory of the attached consumable, the change to the new threshold is not performed, and
wherein, in a case where the attachment of the consumable is detected in the image forming apparatus and the execution of the delivery request is not recorded in the internal memory of the attached consumable, the change to the new threshold is performed.

4. The image forming apparatus according to claim 1,
wherein, when the attachment of the consumable is detected, and the capacity information of the attached consumable is the same as the capacity information of the previously attached consumable, the change to the new threshold is not performed, and
wherein, in a case where the attachment of the consumable is detected, and the capacity information of the attached consumable differs from the capacity information of the previously attached consumable, the change to the new threshold is performed.

5. The image forming apparatus according to claim 1,
wherein, in a first mode, the change to the new threshold is controlled based on a user operation indicating whether to change the threshold, and
wherein, in a second mode, the change to the new threshold is controlled without requiring the user operation.

6. A processing method in an image forming apparatus, the processing method comprising:
performing a delivery request of a new consumable when a remaining amount of a consumable is less than or equal to a threshold; and
in response to detecting attachment of the new consumable, changing the threshold to a new threshold based on:
the threshold,
capacity information of the new consumable, and
capacity information of a previously attached consumable.

7. The method according to claim 6, wherein the change to the new threshold is controlled based on a user operation indicating whether to perform the change.

8. The method according to claim 6,
wherein, when the attachment of the consumable is detected, and the capacity information of the attached consumable is the same as the capacity information of the previously attached consumable, the change to the new threshold is not performed, and
wherein, in a case where the attachment of the consumable is detected, and the capacity information of the attached consumable differs from the capacity information of the previously attached consumable, the change to the new threshold is performed.

9. The method according to claim 6,
wherein, when attachment of the new consumable is detected, and the capacity information of the new consumable is the same as that of the previously attached consumable, the change to the new threshold is not performed; and
wherein, when the capacity information of the new consumable differs from that of the previously attached consumable, the change to the new threshold is performed.

10. The method according to claim 6,
wherein, in a first mode, the change to the new threshold is controlled based on a user operation indicating whether to perform the change; and
wherein, in a second mode, the change to the new threshold is controlled without requiring the user operation.
